(19) United States
(12) Patent Application Publication
(10) Pub. No.: US 2012/0049523 A1
(43) Pub. Date: Mar. 1, 2012

(54) WIND JET TURBINE II

(76) Inventor: Shamel A. Bersiek, Laguna Hills, CA (US)

(21) Appl. No.: 13/318,085

(22) PCT Filed: Apr. 29, 2010
(86) PCT No.: PCT/US2010/033025

§ 371 Date: Oct. 28, 2011

Related U.S. Application Data
(63) Continuation-in-part of application No. PCT/US2010/027531, filed on Mar. 16, 2010.
(60) Provisional application No. 61/173,889, filed on Apr. 29, 2009.

(51) Int. Cl. H02P 9/04; F03D 9/00

(52) U.S. Cl. 290/44; 290/55

(57) ABSTRACT

A wind jet turbine with fan blades located on an inner and outer surface of a cylinder allowing wind or liquid to pass through the inner and outer blades and results in increased power generation efficiency in a first embodiment, a wind jet turbine is disclosed, comprising a first set of fan blades, a plurality of magnets that each has a magnetic field, a cylinder having an inside and outside surface that supports the first set of fan blades on the inside surface and coupled to the plurality of magnets, and at least one cable winding located apart from the magnets, such that the rotation of the cylinder results in the movement of the magnetic field across the at least one cable winding.

### CROSS-REFERENCE TO RELATED APPLICATIONS

This application claims priority to U.S. Provisional Patent Application Ser. No. 61/173,889, titled WIND JET TURBINE II, filed on Apr. 29, 2009, and PCT Application No. PCT/US2010/027531, filed on Mar. 16, 2010, that claims priority to U.S. Provisional Patent Application Ser. No. 61/210,215, titled WIND JET TURBINE, filed on Mar. 16, 2009 and U.S. Provisional Patent Application Ser. No. 61/173,889, titled WIND JET TURBINE II, filed on Apr. 29, 2009, all of which are incorporated herein by reference.

### BACKGROUND OF THE INVENTION

1. Field of the Invention

The present invention generally relates to a power generation device/generator and more specifically relates to power generating devices with rotational blades.

2. Related Art

Wind turbines are traditionally designed to capture the wind via rotating blades that turn a generator unit located at the center or hub of the blades. The power produced by this type of generator is proportional to the wind velocity, swept area, and air density (Power=0.5×Swept Area×Air Density×Velocity³). Unfortunately, traditional wind turbines are expensive, inefficient and occupy a considerable amount of space. Traditionally, wind power devices have utilized many different technologies for blades, gearboxes, and electrical generators, but still produce limited amount of power due to the fact that all the designs are basically similar and follow the same generator principles, namely traditional three bladed propeller windmill designs.

Several companies make three bladed propeller windmills or wind turbines. The three bladed wind turbines are designed to capture the wind via the three rotating blades that turn a generator unit located in the center of the blades. Thus, the three blade wind turbines produce electrical power by rotational torque that is created by the surface area of the blades. The most effective part of the blades is the portion that travels through the greatest volume of air. That part is found at the tips of the blades. Unfortunately the three-bladed turbine blade tips surface area calculates to be less than 10% of the total surface area.

It would be useful to produce power using rotating blades in a small footprint while increasing the effective part of the blades in order to produce two to five times the power as traditional devices while occupying the same space as the traditional three bladed wind turbines.

### SUMMARY

The present blade design is unique with the total area of the blades being located on the outside 50% of the assembly while eliminating the inner 50%, thus reducing the total weight of the blades. By eliminating the inner 50% of the blades, this invention introduces a “ported” aerodynamic system which allows the inner 50% of the wind to pass though the first blades of the wind jet turbine without interruption and the outer 50% to be angularly redirected. The blade shape creates a Venturi effect that causes the wind speed to increase while passing through the ported center section of the wind jet turbine. The combination of the increased inner wind speed and the redirected outer wind speed of the air leaving the turbine may result in an unchanged wind speed at the tail end of the wind jet turbine. Betz law was created in 1919 and published in 1926 and is used to calculate the power output of a wind turbine by the differential wind speed entering and leaving the wind turbine or blades. Betz law defines 0.59% as being the limit of the amount of power that may be derived from an air mass passing through the swept diameter of a rotor or blade.

Thus, an increase in power production is achieved when the wind speed is significantly unchanged between entering and leaving the wind jet turbine. Additionally, the wind jet turbine eliminates the aerodynamic bubble that typically forms over the wind turbines. This approach also eliminates Betz law from applying to the entire wind jet turbine. Rather Betz law only applies to each blade individually in the wind jet turbine.

The wind jet turbine may be designed with blades contained within a housing that maximizes wind capturing and effective striking area. The electric generator may be designed to reduce losses and increase efficiency. The power generation may be achieved with electrical generators, such as AC synchronous, induction, permanent magnet (PM), DC, multiple step permanent magnet RPM multiplier generator (MSG), and pulse magnetic controlled generator (PMCG).

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 shows a perspective and diagrammatical view of an embodiment of the wind jet turbine in accordance with an example implementation of the present invention.

FIG. 2 shows a perspective and diagrammatical view of multiple embodiments of the wind jet turbine of FIG. 1 on a single structure or pole in accordance with an example implementation of the present invention.

FIG. 3 shows a perspective and diagrammatical view of an embodiment of the rotating blades of the wind jet turbine of FIG. 1 in accordance with an example implementation of the present invention.

FIG. 4 shows a perspective and diagrammatical view of an embodiment of the main blade biased by a spring in the wind jet turbine of FIG. 1 in accordance with an example implementation of the present invention.

FIG. 5 shows a perspective and diagrammatical view of an embodiment of the magnet at the end of each rotating blade in the wind jet turbine of FIG. 1 in accordance with an example implementation of the present invention.

FIG. 6 shows a perspective and diagrammatical view of an embodiment of the permanent magnet and spring at the end of each rotating blade of wind jet turbine of FIG. 1 in accordance with an example implementation of the present invention.

FIG. 7 shows a diagrammatical view representation of the main generator power core and windings of wind jet turbine in accordance with an example implementation of the present invention.

FIG. 8 shows a diagrammatical view representation of the wave form of a variable width magnet signal generated by the wind jet turbine of FIG. 1 in accordance with an example implementation of the present invention.

FIG. 9 shows a diagrammatical view representation of the main generator power core and windings for generating Direct Current (DC) power from the wind jet turbine of FIG. 1 in accordance with an example implementation of the present invention.

FIG. 10 shows a diagrammatical view representation of the main generator power core and windings example of the generating Alternating Current (AC) from the wind jet turbine of FIG. 1 shows accordance with another example implementation of the present invention.

FIG. 11 shows a block diagram of the control circuit for sensing, reporting and controlling the transistor firing for the induced magnet coils in accordance with an example implementation of the present invention.

FIG. 12 shows a diagram depicting a “U” shaped rotor and the stator coils together in an assembly in accordance with an example implementation of the present invention.

FIG. 13 shows a flow diagram of the generation of current by the wind jet turbine of FIG. 1 in accordance with an example implementation of the present invention.

FIG. 14 depicts three views of a second wind turbine implementation in accordance with an implementation of the invention.

FIG. 15 shows the three views of the sets of fan blades of the second wind turbine implementation of FIG. 14 in accordance with an implementation of the invention.

FIG. 16 depicts the wind turbines of FIG. 14 mounted on rotatable supports in accordance with an implementation of the invention.

FIG. 17 shows a diagram of the inner and outer blades of a wind turbines with a power generation located at a hub located in the center of the wind turbine blades in accordance with and implementation of the invention.

FIG. 18 depicts the second wind turbines mounted on rotatable supports of FIG. 16 in a natural setting in accordance with an implementation of the invention.

FIG. 19 shows a diagram of the second wind turbines of FIG. 14 mounted as a pair on a single rotatable support in accordance with an implementation of the invention.

FIG. 20 shows a diagram of the inner fan blade of FIG. 17 with each blade having a variable pitch control in accordance with an implementation of the invention.

FIG. 21 depicts the inner and outer blades of FIG. 17 made out of carbon fiber in accordance with an implementation of the invention.

FIG. 22 depicts a cut-away view of the second wind turbine of FIG. 14 identifying the multi-step generator coils and windings in accordance with an implementation of the invention.

FIG. 23 depicts a close-up cut-away view of the multi-step generator coils and windings of FIG. 22 in accordance with an implementation of the invention.

FIG. 24 depicts a 60 Hz waveform generated by the multi-step generator of FIG. 22 in accordance with an implementation of the invention.

### DETAILED DESCRIPTION

Unlike the known approaches previously discussed, a wind jet turbine as disclosed herein overcomes the above limitations. For example, one of the implementation of this wind jet turbine may be a wind turbine in a wind farm. The physical size for the grid application wind jet turbine may be from a few feet to hundreds of feet. Another example application of a wind jet turbine may be for residential use to generate power for building in the range of 1-2 Kilowatt to a few Megawatts. The physical size of residential and commercial wind jet turbines may be from a foot to several feet (such as 20 feet).

Another application of a wind jet turbine may be generating power for vehicles, boats, planes and/or any moving vehicle with the generated power in the Kilowatt range. The physical size of a vehicle wind jet turbine would be from a few inches to a few feet. Furthermore, the approach for generating power with the wind jet turbine is not limited to wind, but may be employed with any current or mass (i.e., fluid—where fluid includes wind) that can produce force to rotate the blades, such as water. The wind jet turbine may also be used to produce power for emergencies, such as backup power for a building.

The housing and blade design may generate power by rotating a standard power generator, for example, with a rotor and stator such as in a conventional diesel generator or may generate power by utilizing direct current (DC) generation approach or a new type of generator based on the principals of a rotating machine that utilizes the principals of magnets, multiple poles RPM multiplier, step generation in combination with duration of magnetism and electric cancellation in one system. The two examples of this type of generators may include Multi-step Generators (MSG) and Magnetic Pulse Controlled Generators (MPCG).

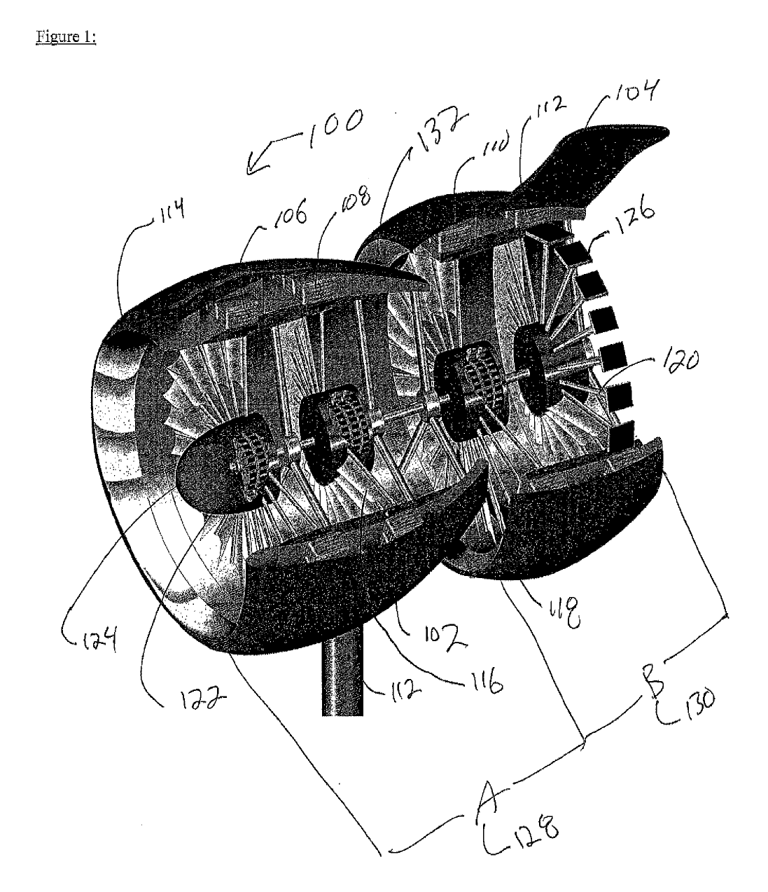

Turning to FIG. 1, a perspective and diagrammatical cut view of an embodiment of a wind jet generator 100 in accordance with an example implementation of the present invention is shown. The wind jet generator 100 may have a housing 102 and one or more metal winding 106, 108, 110, and 112 integrated in the housing 102. In other implementations, the metal windings 106, 108, 110 and 112 may be located within the housing 102 or upon the housing 102. The housing 102 may also have a fin 104 that aids in turning the wind jet generator 100 into the wind. The housing 102 or other mounting area may be rotatably mounted to a pole 112 or other support structure.

One or more sets of blades, such as stage one blades 114, stage two blades 116, stage three blades 118, and stage four blades 120, may be rotatably secured within the housing. The sets of blades may be secured to a single shaft as shown in FIG. 1 or individually to smaller shafts in other implementations. The sets of blades, such as 114, 116, 118, and 120, may each be secured to a respective hub (i.e., set of blades 114 secured to hub 122) that may also rotate around an inner set of metal windings 124. Each blade in a set of blades may have an outer blade tip area 126 that may be magnetic or electro-magnetic. The blades may have fan portions that do not fully extend from the hub to the blade tips as in the present example implementation, or in other implementations the fan blades may extend fully from the hub to the blade tips.

Maximum power relative to the amount of wind velocity occupying a relatively small area compared to traditional three blade wind turbines is achieved with the wind jet turbine 100. The housing 102 of the wind jet turbine 100 may be divided into two sections, section A 128 and section B 130. In other implementations, the housing may be made of only one section or more than two sections. Section A 128 of housing 102 captures the wind and directs it to the stage one blades 114 and stage two blades 116. In some implementations, the stage one blades 114 may rotate in a direction opposite of the stage two blades 116. Section B 130 captures the wind coming through section A 128 in combination with outside wind directed through an opening 132 formed between sections A 128 and B 130.

Section B 130 captures the wind and directs it to the stage three blades 118 and stage four blades 120. In some implementations, stage three blades 118 may rotate in the same direction as stage one blades 114 and stage four blades 120 may rotate in the same direction as stage two blades 116. The wind striking the areas of the blades in combination with the counter rotating blades increases wind capturing while increasing the stability within the wind jet turbine.

The shape of the housing 102 increases the wind speed and increases the air density inside the wind jet turbine while creating a density deferential between the air within the housing 102 and the outside passing wind. The air density increases the power of the wind inside of the housing when striking the blades in accordance to the formula (Power=0.5×Swept Area×Air Density×Velocity³).

The interior section of the housing 102 may be configured or formed to capture the wind through a large opening area 132 and direct the wind through the interior of a decreased diameter area (see B 130 of FIG. 1). The decreasing diameter and area of the interior section results in wind speed and wind density being increased which translates into increased power.

The housing 102 of FIG. 1 increase the distance of travel of the wind around the exterior of the housing 102 and creates the wind speed differential between the interior and the exterior of the wind jet turbine. This differential creates or results in a vacuum at the tail end of the housing 102 and increases the speed of the wind traveling through the interior section. The increased pressure and wind speed in the interior of the housing 102 compared to the lower pressure on the exterior of the housing 102 results in more stability of the total structure of the wind jet turbine.

The blade tip surface area 126 may be increased, for example, 20 to 1000 times, compared to traditional wind turbines of similar size. This increase of the outer blade tip surface area goes through a tremendous volume of wind and creates extremely high torque. The blade design of FIG. 1 is unique as the total area of the blades is located on the outside 50% of the blades assembly eliminating the inner 50%, thus reducing the total weight of the blades. By eliminating the inner 50% of the blades the current approach introduces a ported aerodynamic system that allows the inner 50% of the wind entering the housing 102 to pass though the wind jet turbine without interruption and the outer 50% to be angularly redirected.

The blade design creates a Venturi effect that causes the wind speed to increase while passing through the ported center section of the housing 102 of the wind jet turbine 100. The combination of the increased inner wind speed and the redirected outer wind speed leaving the turbine results in an unchanged wind speed at the tail end (end with tail 104) of the wind jet turbine.

Betz law was published in 1926 and defined 0.59% as being the limit of the amount of power that may be derived from an air mass passing through a swept diameter of a rotor. Betz law calculates the power output of a traditional wind turbine by the differential wind speed entering and leaving the turbine or blades. The wind jet turbine approach thus results in tremendous power production with a relatively unchanged wind speed entering and leaving. In addition, the current wind jet turbine approach eliminates the aerodynamic bubble that typically forms over wind turbines by having the wind speed entering and leaving the wind jet turbine approximately equal. The wind jet turbine approach also eliminates Betz law from applying to the entire wind jet turbine. Rather, Betz law applies only to each blade of the wind jet turbine individually.

With Betz law applying to each blade of the wind jet turbine individually instead of relating to the overall turbine and blade diameter, advancement in technology of wind turbine design is achieved. By using the standard formula Lf×Wp=Fp (Leverage feet×Wing pounds=Foot pounds), multiplying the foot pounds of torque times the number of wings in turbine to find the total power of the wind turbine resulting in a total power formula of:

Total power=(Lf×Wp)×number of wings.

By having high number of aerodynamic blade tips at the farthest distance from the center of rotation (blade tips 126), the wind jet turbine 100 is able to convert wind energy exerted on individual wings in the sets of blades (114, 116, 118, 120) into high torque leverage resulting in higher power output than traditional wind turbines of similar size.

The wind jet turbine blades of a large wind jet turbine n accordance withy the present invention weigh only in hundreds pounds each compared to the traditional large three-bladed turbines that weigh thousands of pounds each. The present invention introduces lighter weight blades and structure that can rotate at higher RPM, for example, three to four times the RPM of traditional wind turbines without affecting the stability of the total assembly. This added stability at high RPMs eliminates the need for a transmission/gearbox and at the same time takes advantage of the RPM increase to produce additional power. Furthermore, the lighter blades may be made lighter with the use of light weight materials, such as aluminum or plastic.

For example, if a traditional wind turbine has a 25 foot radius and captures 100 pounds of force per blade at a 20 mph wind speed, then the total torque is:

25Lf×100×3Wp=7,500 f.lb.

In the present wind jet turbine approach, with a 25 feet radius (housing 102 front opening), 21 blades and 100 pound of force at a 20 mph wind speed the torque is;

25Lf×100×21Wp=52,500 f.lb.

By using the formula:

Power(kW)=(Torque×2×3.14Rpm)/60000,

the present approach introduces a high torque wind jet turbine that is small in diameter and high in RPM. The wind jet turbine produces seven times the torque and three to four times the RPM and results in 21-28 times more power than traditional wind turbines of similar size.

In FIG. 2, a perspective and diagrammatical view of an embodiment 200 with multiple wind jet turbines 202, 204, 206, and 208 coupled to a single structure or pole 210 in accordance with an example implementation of the present invention is shown. The counter rotating blades increase the stability of the wind jet turbines 202, 204, 206, and 208, allowing for grouping them in close proximity to each other and sharing a support structure, such as pole 210. A greater number of wind jet turbines may also be placed in the same space foot print as a single traditional wind turbine. Each of the wind jet turbines 202, 204, 206, and 208 may have a tail that aids in keeping the wind jet turbines 202, 204, 206, and 208 facing into the wind. In other implementations, one or more fins may be located on the support structure rather than on the wind jet turbines.

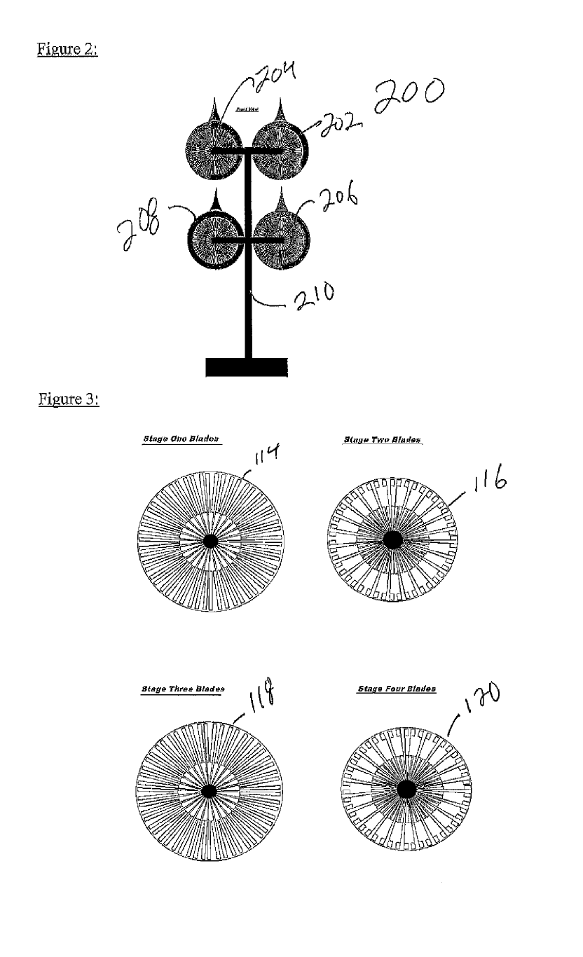

Turning to FIG. 3, a perspective and diagrammatical view of an embodiment of the rotating blades of the wind jet turbine in accordance with an example implementation of the present invention is shown. The blades of the wind jet turbine are designed to adapt to any wind speeds from one mph to 250 mph. Three types of aerodynamic principles are employed by the wind jet turbine: (1) compression with the wing blades design, (2) vacuum with the outside aerodynamic body design; and (3) angle of attack with the variable blade pitch angle. Where the blades may be lined up in parallel to the wind direction with variable pitch that ranges from 5-85 degrees. The pitch may be controlled with springs and shaft, hydraulics, or mechanical linkage that are able to change the pitch angle of the blades.

Stage one blades 114 may be similar to stage three blades 118, but with the blades going in opposite directions. Stage two blades may be similar to stage four blades but with the blades also going in opposite directions.

The wind jet turbine 100 enhances the efficiency of the blades by utilizing multiple blades, for example, from 20 to 1000 blades. The multiple blades and reduced inner blade area increases the effectiveness of the wind striking areas of all blades in all stages, for example, by eliminating the inside 50% of the blades in all stages (114, 116, 118, and 120) or eliminating the inside 50% of stage one blades 114 and stage three blades 118 and the middle to outside 50% of stage two blades 116 and stage four blades 120. This allows significant air to pass through the center of and the sides of the blades so an aerodynamic bubble does not form over the wind jet turbine 100 and eliminates Betz law from applying to the entire wind jet turbine. Each blade of the wind jet turbine in the current example has a 0.59% Betz limit.

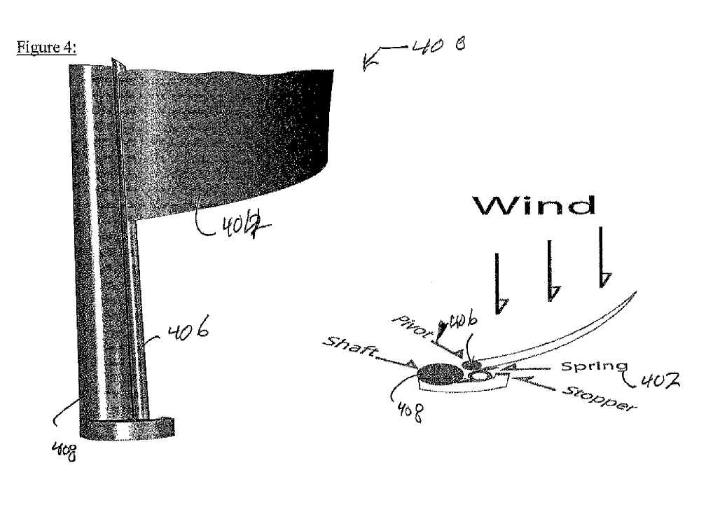

In FIG. 4, a perspective and diagrammatical view of an embodiment of a blade 400 and spring 402 assembly for the example wind jet turbine 100 is shown. Each of the blades in a set of blades may be designed with two sections; both sections may be concaved in the same direction creating a bird's wing type of blade. The blade's inner surface area increases the wind capturing area and the outer surface reduces the drag as the blades are rotating.

The blades of the different stages of fan blades (114, 116, 118, and 120) may also be designed with springs and shafts. Each fan blade, such as blade 404, is able to pivot on a rod or support 406 that may be next to the shaft 408. A spring 402 or other resistance producing device may bias the fan blade 404 in a first position or resting position. The spring 402 may be formed so that a blade 404 opens or move as the wind speed increases. For example, the blade may move from an eighty-five degree wind angle to a five degree wind angle as the speed of wind increases from one mile an hour to two-hundred and fifty miles per hour.

The blades of the wind jet turbine may generate power with an electric generator. The power coils and magnets may be wired differently within the same housing to generate either Alternating Current (AC) on Direct Current (DC) sources. The electric generator is designed to reduce losses and increase efficiency. The power generation in the generator section is based on a new principal of generating power in a rotating machine utilizing the principals of magnets in combination with duration and electric cancellation called Magnetic Width Modulation (MWM). The MWM principle may be applied to motors, generation or any machine where magnetic variation is needed.

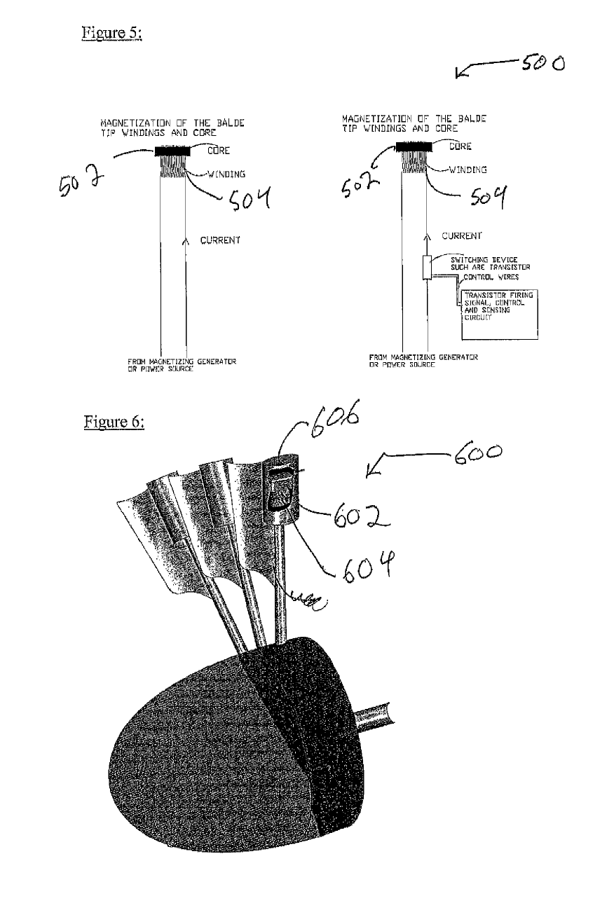

Turning to FIG. 5, a perspective and diagrammatical view 500 of an embodiment of an induced magnet 502 at the end of each rotating blade of wind jet turbine 100 in accordance with an example implementation is shown. The wind jet turbine 100 may use main permanent magnets and/or induced magnets 502 located at the tip of the blades. The main power coils 106, FIG. 1 may be located on or in the housing 102 of the wind jet turbine. At the center of the assembly and attached to the blades (for example, see 124, FIG. 1), a small magnetizing generator or power source may induce and magnetize the cores that become the induced magnets 502 and windings 504 located on the tip of each blade. The induction or magnetizing of the core 502 may occur periodically and relative to the rotational speed of the blades.

The magnetizing generator 124 or power source may be located in the center of the wind jet turbine 100 and increases or decreases the current delivered to the induced magnet coil 504 at the tips of the blades relative to the rotational speed of the fan blades (and magnetizing generator 124). The increasing or decreasing of the magnetic strength which will increase or decrease the power output of the wind jet turbine is thus modified with the rotation of the fan blades. In other words, the increase and decrease of current may be relative to the wind speed or velocity and/or the rotation or rounds per minute (RPM) of the turning blades.

Turning to FIG. 6, a perspective and diagrammatical view 600 of an embodiment of the permanent magnet 602 and spring 604 at the end of each rotating blade 606 of wind jet turbine 100 in accordance with an example implementation is shown. With the permanent magnet 602 rotating within the windings (see 106, FIG. 1); the flux strength variation may be mechanically controlled by increasing or decreasing the distance of the permanent magnets from the main power coils (sometimes referred to as windings). The permanent magnet 602 may be equipped with a variable or biasing mechanism, such as spring 604, located at the blade end 606 that moves in response to the centrifugal force of the blade and adjusts and/or varies the distance of the permanent magnet 602 relative to the main power coils 106 of FIG. 1. This will maximize the power output of the wind jet turbine 100 at any speed by synchronizing the magnetization strength introduced to the main power winding coils 106 with the wind speed. This variable magnetization approach enables the wind jet turbine 100 to harness the smallest amount of wind more efficiently than traditional wind turbines.

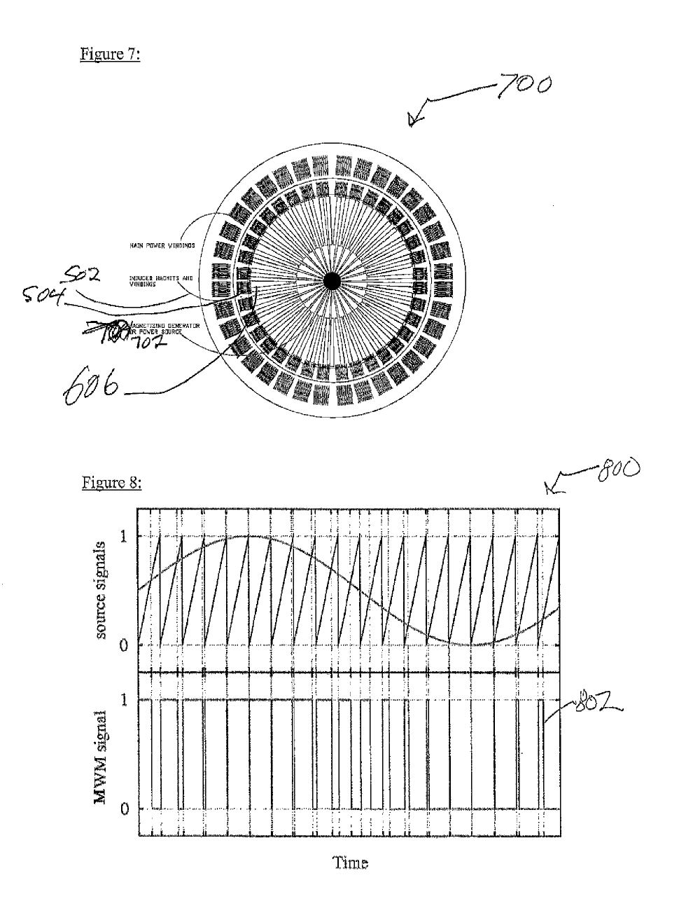

In FIG. 7, a diagrammatical representation 700 of the main generator power core and windings of wind jet turbine 100 in accordance with an example implementation is shown. Induced magnets (502 core and coil 504) may be located on the tips of the blades 606. The induced magnets may be powered by a small magnetizing generator 702 placed in the center of the housing 102 (i.e., at a hub) on a main shaft. The power from the magnetizing generator 702 may be varied in response to the wind speed and will magnetize the windings on the tips of the blades relative to that response.

The magnetizing generator 702 may be a permanent magnet generator that has power output directed though a variety of silicon controlled rectifiers (SCR) and/or transistors controlled by a control circuit. The control circuit may turn off and on the SCRs and/or transistors and vary the firing timing in order to produce the desired magnitude and proper frequency sequence. By controlling the magnetic field passing through the stator winding, full control of the generator output is achieved. This full control allows for the maximizing of the power output of the wind jet turbine 100 at any speed by synchronizing the wind speed with the transistor firing timing. This control approach results in the magnetization amplitude maximizing the power output of the wind jet turbine 100.

The power coils, permanent magnets and/or induced magnets may be wired differently within the same housing to produce Alternating Current (AC) on Direct Current (DC) sources. The AC power may be delivered to the load or a transformer and produce the desired output for any grid, commercial, vehicle, sea vehicles, and any other applications.

Turning to FIG. 8, a diagrammatical view representation 800 of the wave form of a variable width magnet signal 802 is shown. The power coils, induced magnets and/or permanent magnets are implemented as a variable magnetic wave generator. The variable magnetic wave generator approach may be referred to as Magnetic Width Modulation (MWM). The electronic control system will monitor the generator output waveform 800 (for example, voltage, current, and zero crossing of the waveforms) and the magnet or induced magnet position in relation to the winding position. The electronic control will initial a signal source relative to the waveform and induced magnet position. The signal source is directed through an electronic signal isolator and firing circuit to turn on and off power transistors in a variable format to correct and keep the output waveform 802 potential and frequency at the desired level. The firing circuit is connected to the transistors that pass through a current in variable form (in relation to the source signal) to the windings in the induced magnets.

In FIG. 9, a diagrammatical view representation 900 of the main generator power core and windings example of generating DC power with the wind jet turbine 100 in accordance with an example implementation is shown. The DC power may be delivered to the load or to summing bus bars then to DC-to-DC and/or DC-to-AC converters (i.e., a static converter, an inverter or electro-mechanical converter such as a motor generator) and produce the desired AC or DC output for any grid, commercial, vehicle, sea vehicles, or other application.

The production of DC power may be achieved by utilizing the magnets, such as magnet 902, in the blade tips crossing thought multiple power coils 904. The power coils 904 may be arranged and/or positioned to accept the negative and positive flux of the magnets and redirect the current of both fluxes to produce one current in one direction. This may be achieved by utilizing the power coils connection arrangements and/or by using rectifiers 906, such as diodes/SCRs, thus creating a positive DC waveform 908 from an initial waveform 910 for both positive and negative magnetic fluxes.

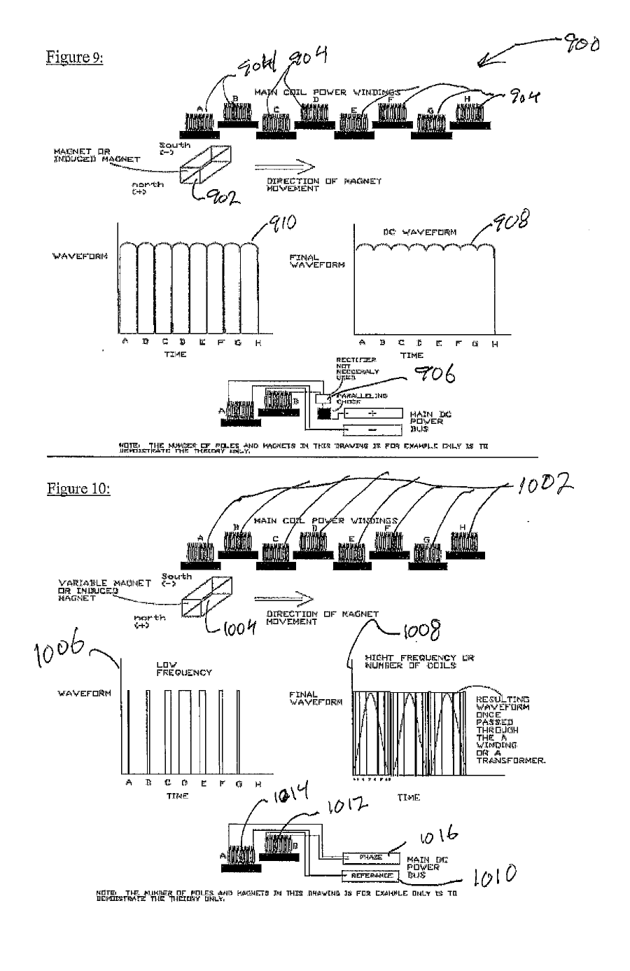

Turning to FIG. 10, a diagrammatical view representation 1000 of the main generator power core and windings 1002 of an example wind jet turbine 100 generating AC power directly in accordance with an example implementation is shown. The production of AC power directly by the wind jet turbine 100 may be accomplished by utilizing an approach of varying the time duration of the magnetic field and associated magnetic flux introduced to the power coils 1002. This may be achieved by utilizing either of permanent magnet tips or induced magnet tips 1004. The varying through time of the magnetic flux's amplitude and frequency results in MWM and may have a waveform as shown in graph 1006. The changes in the magnetic flux introduced to the magnetic winding 1002 on the tip of the blades can be controlled and varied electronically or mechanically to generate a waveform as shown in graph 1008.

The mechanical control of the MWM is preferably designed with variable/different widths of flux-transmitting permanent, induced magnets, and receiving power coils and cores. The electrical control of the MWM is preferably applied to the permanent magnet tips design and is preferably designed with an electronic controlled circuit that produces on/off signals for the transistors similar to Pulse Width Modulation in a predetermined order that control the current flow to the induced magnets. This control of the transistors produces a controlled flux amplitude and duration at the tip of the blades in respect to time and rotation. The reference signal 1010 senses the waveform amplitude, frequency and zero crossing and then sends a reference signal back to the controller. The controller utilizes the reference signal to correct the firing signal going to the transistors, which in turn is fed to the windings 1012 and 1014 as a phase power 1016.

Thus, the MWM approach is able to produce a clean AC waveform. For example, the magnetic field duration changes through time in an increasing then decreasing manner as shown in graph 1008. The magnetic flux changes its duration in the flux exchange area, such as permanent magnet 1004, to main power coils or induced magnets to the main power coils. For induced magnets, the flux duration change may be accomplished by either increasing or decreasing the power coil and core size/width of the flux exchange area, and/or by the magnetization duration of the induced magnets on the tips of the blades.

For permanent magnets, the flux duration change may be achieved by either increasing or decreasing the power coil and core size/width of the flux exchange area and/or by the reducing or increasing the permanent magnets size and/or surface area on the tips of the blades. The flux changing through time generates an increasing and decreasing waveform width that when summed and combined at higher frequency will results in a combined AC power waveform.

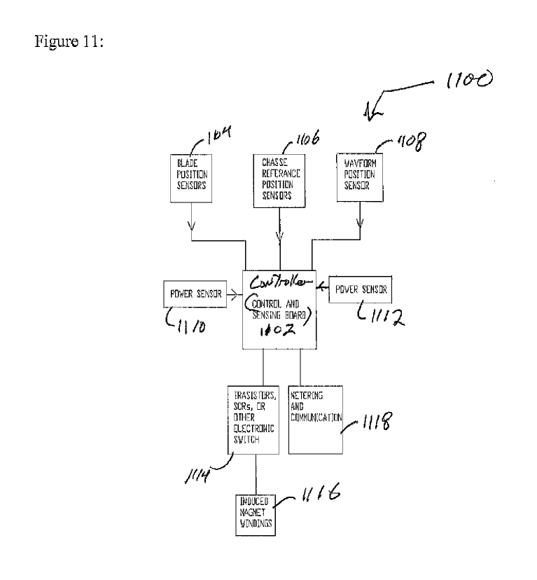

In FIG. 11, a block diagram of the control circuit 1100 for a sensing, reporting and control circuit of the transistor firing for the induced magnets coils in accordance with an example implementation of the present invention is shown. A controller 1102 is in communication with blade position sensors 1104, chasse reference position sensors 1106, wave position sensors 1108, and power sensors 1110 and 1112. The controller 1102 monitors the sensors and generates control signals to the transistors, SRCs, or other electrical switches that control the output power 1114. The types of controls will vary depending on the type of current being output by the wind jet turbine 100. The transistors, SCRs, or other electrical switches 1114 may also be in communication with induced magnet windings 1116 in order to adjust the flux of the induced magnet. The controller 1102 may also be coupled to reporting devices and ports, such as metering and communication block 1118. The metering and communication block 1118 may contain internet connections or modems for communicating with the controller and accessing data along with storage, such as disk drives and memory for storing operating data and metrics in a database for later processing and reporting. The controller may be implemented as a single control device, such as an embedded controller or digital signal processor, a microprocessor, or a control and sensing board made up of one or more of embedded controllers, digital signal processors, microprocessor, display, and logic devices (discrete and analog).

The blade position sensors 1104 may sense the blade/winding position in relation to the induced magnet or magnet position and sends the signal to the controller 1102. The waveform position sensor 1108 may sense the current and voltage as it crosses the zero position (the zero position is when the voltage is zero and/or the current is zero) and transmits the signal to the controller 1102. The power sensors 1110 may monitor the output voltage and current levels and send the signal to the controller 1102. The metering board and communication block 1118 translates, transmits and displays all power information and electrical operation of the wind jet turbine 100. The controller 1102 may translate and otherwise process all incoming signals from the blade sensor, wave sensor, and power sensor boards. The controller 1102 may then send the appropriate signals (on and off signals) to the transistor and/or SCR electronic switch 1114 that controls the amount of current, frequency and voltage of the induced magnets in relation to the position of the magnets and waveforms.

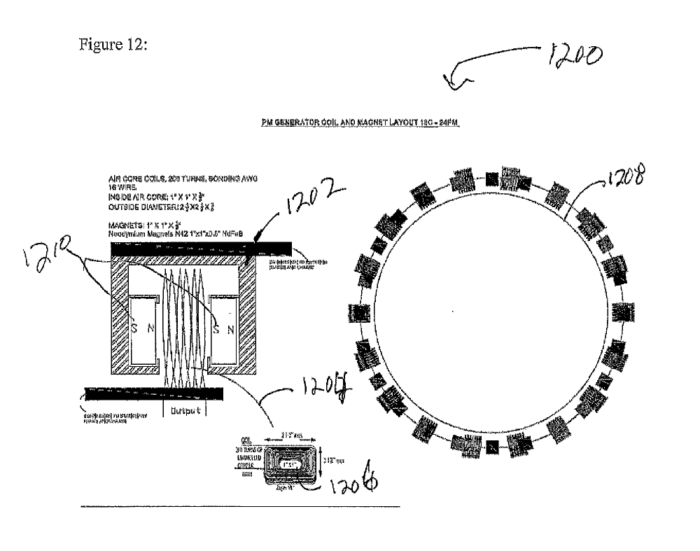

Turning to FIG. 12, a drawing of a U-shaped rotor 1202 and the stator coils 1204 together in one assembly in accordance with an example implementation of the present invention is shown. The physical arrangement of the generator, the number of turns and coil sizes varies depends on the kW size of the wind turbine generator 100. The stator section of the permanent magnet and the MWM pulse generator may be designed with coils that are coreless 1206. The coils may be placed in a circular frame 1208 that is fixed to the main assembly. The rotor of the generator may have permanent magnets or induced magnets 1210 (plurality of magnets) that are formed or set in a U-shaped assembly facing each other with the positive side of one permanent magnet or induced magnet facing the negative side of the other permanent magnets or induced magnets where the magnets have a magnetic field or flux. The U-shaped rotor assembly allows the rotor to embody the stator section where the coils will be passing through the U-shaped rotor and crossing the magnetic field at an optimum angle. Multiple U-shaped rotor assemblies may be placed around the generator.

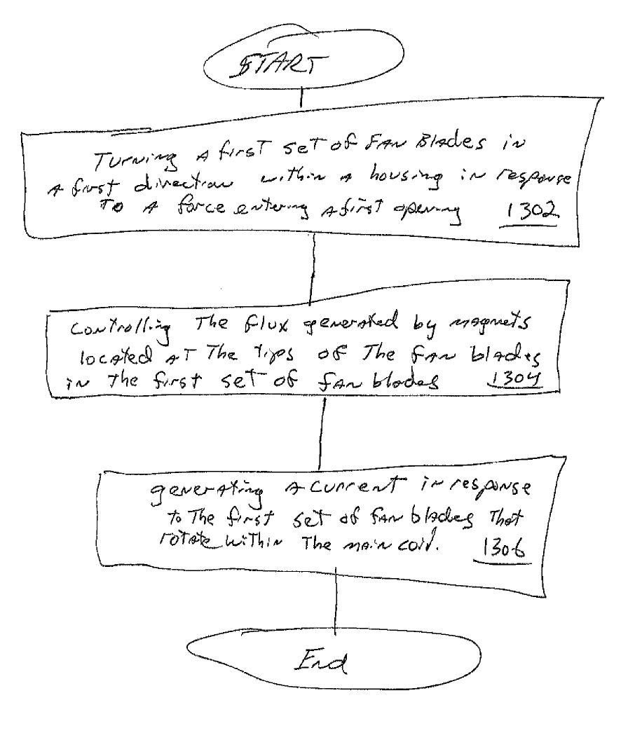

In FIG. 13, a flow diagram 1300 of the generation of current by the wind jet turbine of FIG. 1 in accordance with an example implementation is shown. A housing that has at least one set of blades 114, FIG. 1, turns in a first direction in response to a force, such as wind or water passing over the set of blades 1302. The flux generated by the magnets located at the tips of the fan blades in the first set of fan blades is controlled or altered 1304 by altering the position of the magnets or if induced magnets are employed, altering the induced current running through the coils of the induced magnets. The altering of the induced current and the direction of the winding of the coils of the induction magnets may be controlled in a way to generate alternating current, such as with MWM. As the flux generated by the magnets located at the tips of the fan blades pass through the main coil, a current may be generated 1306.

The magnets are described as being located at the tips of the fan blade. The term “at the tips” may mean at the very end of the fan blade, in a side of the fan blade at a region close to the end of the fan blade, or attached to the blade at a region close to the end of the fan blade.

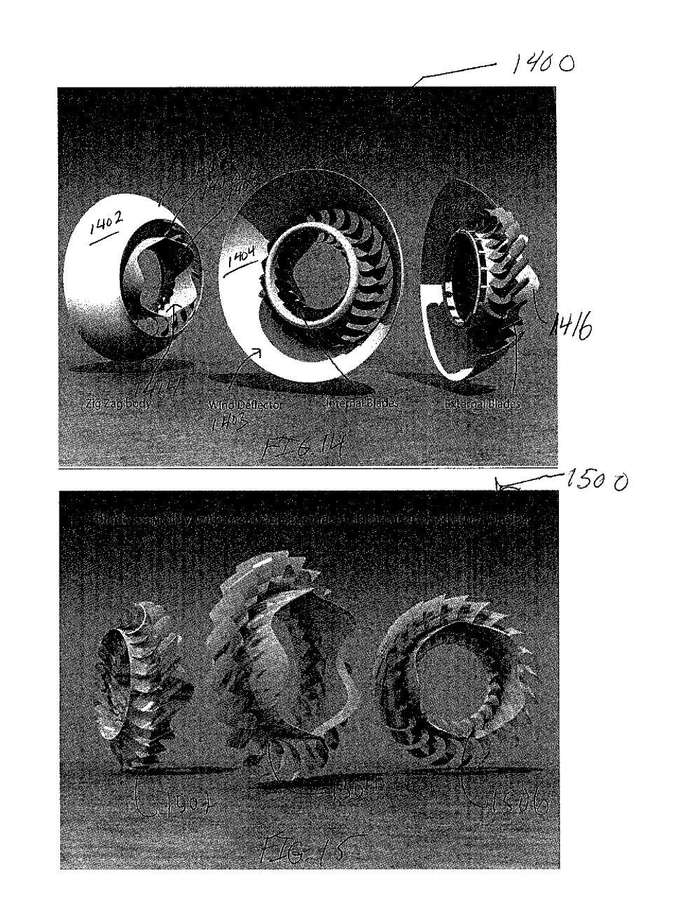

Turning to FIG. 14, a diagram 1400 of three views 1402, 1404 and 1406 of a wind turbine in accordance with another implementation of the invention is shown. The first view 1402 depicts a side and rear view of the wind turbine that has inner 1408 (first set of fan blades) and outer 1410 (second set of fan blades) rotating blades, and is hereafter referred to as the inner outer rotating blades windmill (IORBW). The body of the IORBW 1402 may have an outer housing 1412 that encompasses the inner and outer fan blades that may be formed on a cylinder that has and an exit port 1414 for liquid, such as wind or water to exit the IORBW 1402.

The cylinder may have an inside surface supporting the inner set of fan blades and an outer surface that supports the outer set of fan blades that make up the rotating blades. The walls or end of the cylinder may be called the exit port 1414 and have a zigzag pattern. The zigzag and wave like shape of the tail end of the IORBW's exit port 1414 creates lift and rotational momentum that increases the stability of the IORBW 1402. In the present implementations, the blades are shown as being placed on the interior and exterior of a cylindrical structure with an exit port 1414 that ends in a zigzag edge. The inner blades 1408 and outer blades 1410 may be positioned parallel to the cylinder length in order for the wind that passes through the IORBW 1402 to strike them.

The inner blades 1408 and outer blades 1410 may be tunable having a variable pitch from 85-5 degrees in the current implementation. The physical area of the blades increases the effective wind striking area of all blades without interrupting the wind speed passing through the IORBW 1402. The wind is allowed to pass through the open center of the IORBW 1402 and the blades without reducing the wind speed. This also prevents an aerodynamic bubble from forming over the wind jet and eliminates Betz law from applying to the entire IORBW 1402. Thus, the IORBW 1402 increases the torque output of the blades 1408 and 1410, while reducing the rotating drag without affecting the rounds per minute (RPM) rotation.

The second view depicts a front facing depiction of the IORB 1404. A wind deflector 1403 may be part of the outer housing of IORBW 1402 and direct wind (or liquid if in a liquid environment) to/across the outer blades 1410. A hole is formed in the center of IORBW 1404 that allows wind or other liquid to pass directly across the inner fan blades 1408. The hole may be reduced in size as wind or other liquid travels through the opening. This reduction may be accomplished by having the inside surface of the cylinder being wider at the entrance to the hole and narrow (hole is not of uniform size going through the cylinder) before the sets of fan blades in order to increase the wind or liquid velocity traveling through the cylinder.

The third view is a cut-away front and side view of the IORBW 1406. The outer blades 1410 may have a curved concave shape and are formed in a direction opposite of the inner blades 1408. Also visible in IORBW 1406 is the zigzag end of the exit port 1416.

The IORBWs 1402, 1404 and 1406 utilize the wind speed traveling through the housing 1412 to rotate the blades (inner blades 1408 and outer blades 1410) while maintaining the wind speed. An increase in wind striking force on the blades area may be accomplished by allowing more volume of wind to pass through the blades and increases the power output of the IORBWs 1402, 1404 and 1406.

The interior section of the IORBWs 1402, 1404 and 1406 may capture the wind through the opening and direct the wind through the interior of the IORBWs 1402, 1404 and 1406. The interior may be of a decreased diameter area in comparison with the exterior diameter. The decreasing diameter and area of the interior section results in a wind speed increase that produces more power.

In FIG. 15, a diagram 1500 of three views 1502, 1504 and 1506 of sets of fan blades of the IORBWs of FIG. 14 in accordance with an implementation of the invention is depicted. The housing inner fan blades 1408 and outer fan blades 1410 are shown. In diagrams 1504 and 1506, the inner fan blades 1408 and outer fan blades 1410 are depicted as being rotatably mounted on the interior and exterior of a cylindrical structure that may have a zigzag end or edge 1414. As the wind passes over the blades, the inner and outer blades may rotate in the same direction. In other implementations the rotation of the inner and out blades may be in opposite directions to offset a torque forces created by the rotating blades.

The blades may be implemented with two sections creating a bird's wing appearance. This shape increases the wind capturing area while reducing the outer surface drag as the blades rotate. This approach results in the torque generated by the blades may be increased with the blades and the rotating drag is reduced.

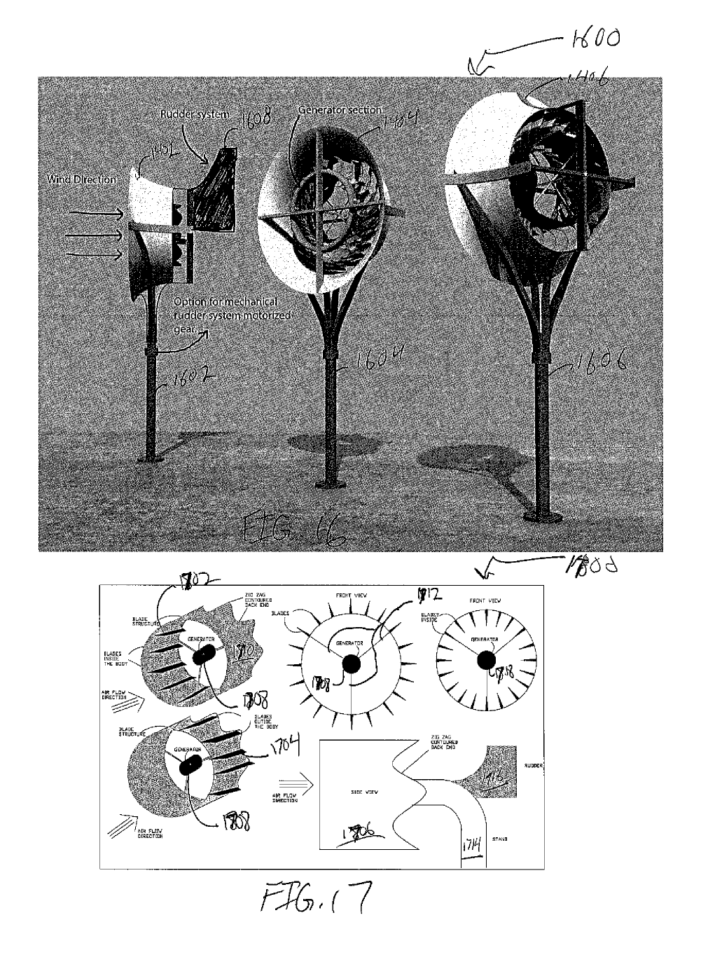

Turning to FIG. 16, the IORBWs 1402, 1404 and 1406 of FIG. 14 are depicted in diagram 1600 as being mounted on rotatable mounts or supports 1602, 1604 and 1606 in accordance with an implementation of the invention. The rotatable mounts 1602, 1604 and 1606 are shown as extending as a single pole all the way to the ground. In other implementations, the rotatable mounts may be any structures that support the IORBWs 1602, 1604 and 1606. In yet other implementations, non-rotatable mounts may also be used on IORBWs that may be located on vehicles or buildings.

The IORBW 1602 is depicted with a tail or rudder 1608. The tail or rudder 1608 may be employed to aid in the turning of the IORBW 1602. As the wind or liquid change directions, a force is applied to the tail or rudder 1608 and the facing of the IORBW 1602 is changed in response to that force. In other implementations, the IORBWs 1602, 1604 and 1606 may be rotated by mechanical means, such as gears, rods, cables and/or belts, hydraulics, or electronic means, such as electric motors and solenoids.

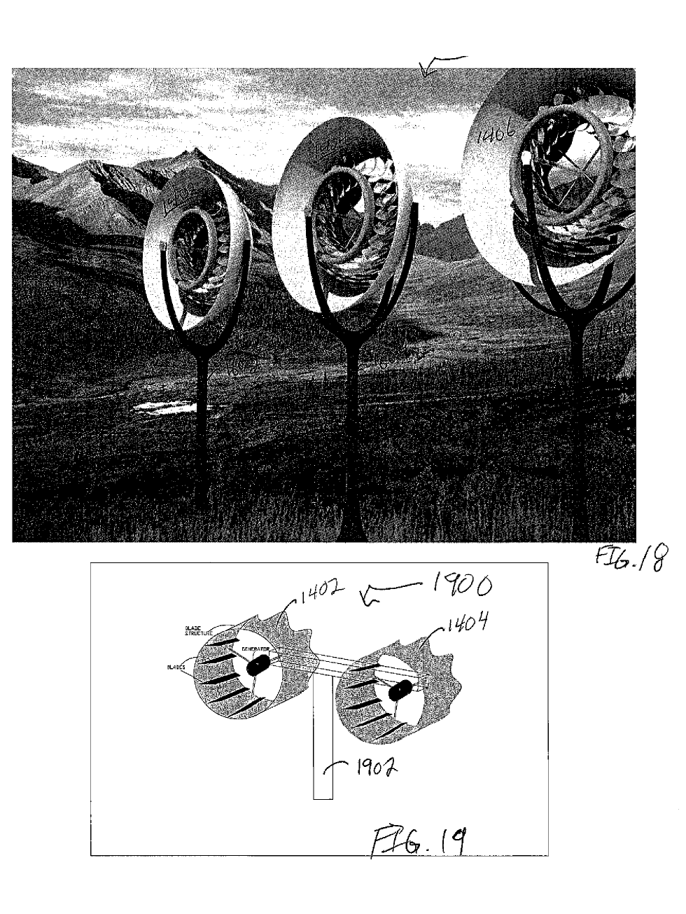

In FIG. 17, a diagram 1700 of the inner blades 1702 and outer blades 1704 of a wind turbine 1706 with a generator 1708 located at a hub in the center of the wind turbine blades 1702 and 1704 in accordance with and implementation of the invention is shown. The inner blades 1702 may be spaced equally apart along the interior of cylinder body 1710 and be rotatable attached to the cylinder body such that the rotating blades results in rotational energy being transferred to a generator 1708 located at the hub or center of the cylinder body 1710. Spokes 1712 may couple or connect the generator 1708 with the cylindrical body 1710. An outer set of blades 1704 may also rotate with the inner set of blades 1702 and transfer the rotation energy with the spokes 1712. The support 1714 for the wind turbine 1706 may support the generator 1708 near or at the hub or center of the cylinder body 1710. A rudder 1716 may be coupled to the wind turbine 1706 and be located on a portion of the support 1714 that is rotatable. In other implementations, the rudder 1716 may be located on or coupled to the body of the IROBW.

Turning to FIG. 18, a depiction of the IROBWs 1402, 1404 and 1406 mounted on rotatable supports 1602, 1604 and 1606 of FIG. 16 in a natural setting in accordance with an implementation of the invention is shown. The IROBWs require less space to produce the equivalent power or energy of traditional three-blade wind generators. This allows the IROBWs to be less obtrusive when placed in natural environment.

In FIG. 19, a diagram 1900 of the IROBWs 1402 and 1404 of FIG. 14 mounted as a pair on a single rotatable support 1902 in accordance with an implementation of the invention is shown. By mounting two or more IROBWs on a single mount, the space required for deploying IROBWs may be further reduced. When compared with traditional three-blade wind generators, significantly more energy may be generated from the same amount of area as required by a traditional three-blade wind generator.

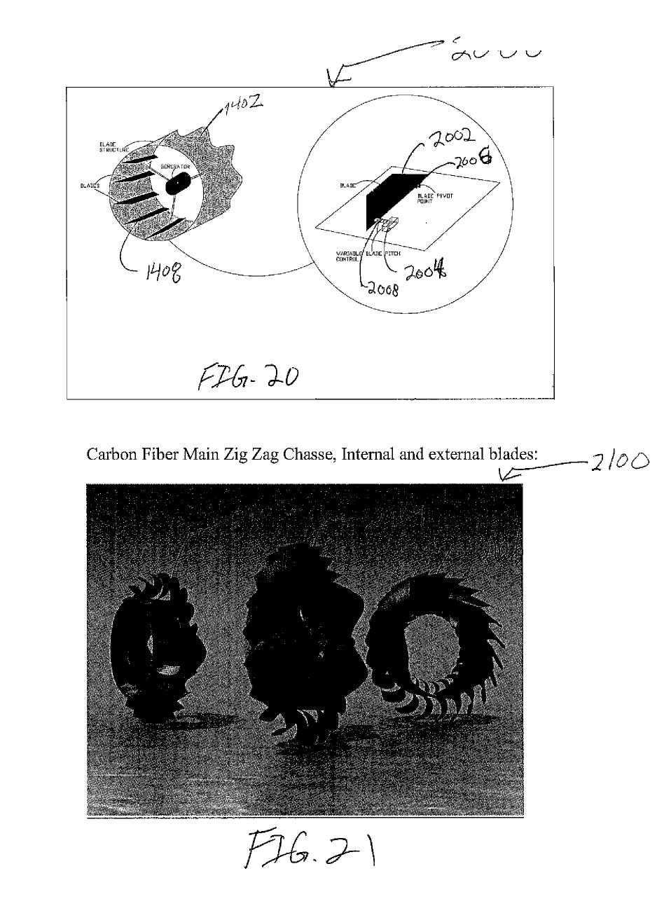

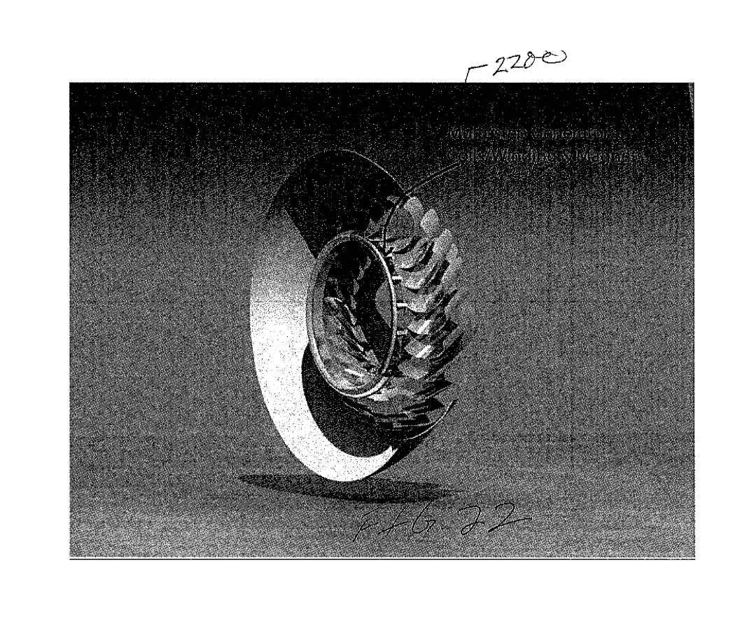

Turning to FIG. 20, a diagram 2000 of the inner fan blades 1702 of FIG. 17 with each blade 2002 having a variable pitch control 2004 in accordance with an implementation of the invention is shown. Each of the fan blades, such as fan blade 2002 may be pivotally secured at a pivot point 2006, such as a hinge. The variable pitch control 2004 may be secured to the fan blade 2002 with a spring 2008. In other implementations, a rod or similar securing means may be employed. The variable pitch control 2004 may be an electronic solenoid that adjusts the fan blade in response to a electronic signal that is sent in response to the wind speed and RPM. The variable pitch control 2004 may also be a block that secures the spring and may be adjustable, such that the fan blade 2002 is in a first position when at rest and a second position while the fan blade 2002 is rotation. The outer set of fan blades may also have variable pitch using similar structures as the inner set of fan blades. In other implementations, a single variable pitch control may change the pitch of all the fan blades.

In FIG. 21, the inner and outer blade assembly 2102, 2104 and 2106 of FIG. 17 may be made of carbon fiber in accordance with an implementation of the invention is shown. In other implementations the fan assembly may be made of aluminum or other types of metal, plastic, other polymer, or a combination of metal and plastic. It is desirable to use strong light weight material for the inner and outer blades assembly in order to enable winds of low velocity to rotate the fan blades. It is also desirable to use strong light weight materials in order to reduce the size of the support or mounting structures.

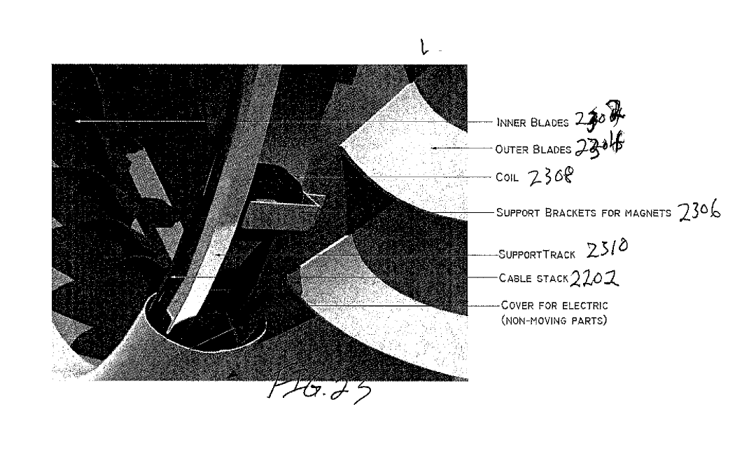

Turning to FIG. 22, a drawing 2200 of a cut-away view of the IROBW 1402 of FIG. 14 identifying the multi-step generator coils 2202 and windings in accordance with an implementation of the invention is shown. The coils 2202 may be fixed and each of the fan blades may have associated magnets that induces a current into the coils 2002. The magnets may be permanent magnets or electronic magnets (See FIG. 5) depending upon the implementation. The multi-step generator is depicted in FIG. 22, but in other implementations magnetic pulse controlled generator or traditional generators may be employed.

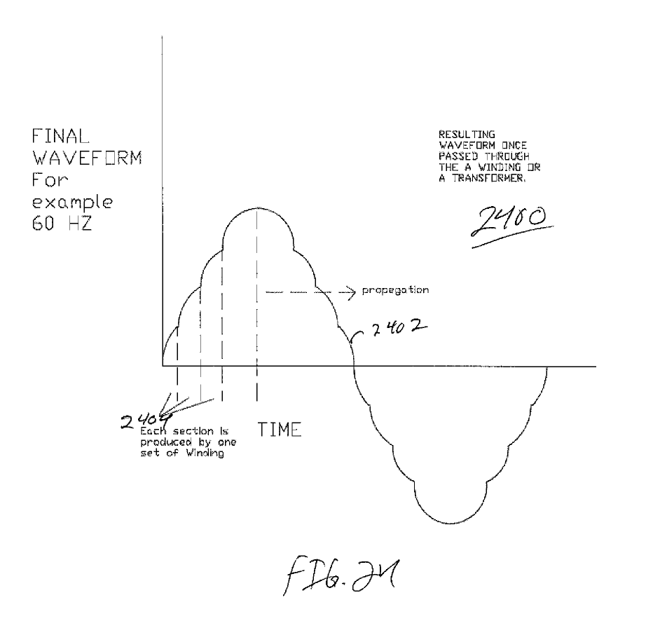

In FIG. 23, a diagram 2300 of a close-up cut-away view of the multi-step generator coils 2202 of FIG. 22 in accordance with an implementation of the invention is shown. The inner blades 2302 and outer blades 2204 may be coupled to the magnets via support bracket 2306. The support bracket may hold a permanent magnet or coil 2308 for induction magnets, depending upon the implementation. The fan blades (2302 and 2304) may turn along with support bracket 2306 and coil 2308. When the coil 2308 is energized it has a magnetic field or flux that crosses the cable winding or cable stack 2202 made up of multiple cable windings. Simply put, the magnets are separated or spaced apart from the cable windings or cable stack 2202 such that one can move without touching the other. The cable stack 2202 may be supported by a fixed support track 2310. A cover may be placed over the cable stack 2202 and fixed support track 2310 to protect the non-moving electrical parts from the elements.

The generator may be implemented as a DC generator, induction generator, synchronous generator, multi-step permanent magnet generator (MSG), or pulse magnetic controlled generator. The multi-step permanent magnet generator typically has multiple poles of windings and permanent magnets, preferable in a 4:3 or 3:4 ratio. For example, the three phase modules may have stator windings in multiples of six and the rotor permanent magnets in multiples of eight (48 rotor permanent magnets and 36 windings). The permanent magnets may be U-shaped with two magnets fading each other (See FIG. 12). The winding may then pass through the U-shaped permanent magnets.

One multi-step MSG may have multiple small generators all within one assembly. For example in an multi-step permanent generator, three phase generator that has a stator with a 36 winding poles and a rotor with 48 permanent magnet poles there are a total of six small generators.

Each small generator may have three phases (A, B and C). Each phase may have two windings for a total of six windings. The multiple small generators may be exposed to the rotor's 48 permanent magnet poles. Each of the small generators will produce a full waveform of 360 degrees in all three phases in a 12.5% of one full rotor rotation. This may result in each small generator being exposed to eight times the RPM in one full rotor rotation.

In rotating machines, the power formula is (power in KW=(Torque×2×3.14×RPM)/60,000), so that higher the RPM the higher the power. The output power of all small generators within IROBW may be synchronized and coupled together selectively to produce a total power output of the small generators. This output typically is synchronized and may be relative to the amount of wind and torque produced by the blades. Thus, the MSG generator may utilize one of the small generators at low wind speed and low torque and couple more small generators to the output bus as the wind speed and torque increases. The addition of each small generator output to the MSG main output bus may be achieved mechanically (switches), electro-mechanically (relays/solenoids), or electronically (analog/digital switching). The output of each small generator within the multi-step permanent generator may be coupled on the AC side or may be rectified then coupled after rectification. The MSG approach may produce any output frequency, such as 60 Hz or 50 Hz independent of the rotational speed of the rotor.

The pulse magnetic controlled generator, may have a rotor that is equipped with permanent or electromagnet magnets, located in the center of the IROBW 1402 and may be attached to the rotating blades or blade assembly. The stationary stator may have a power coil and windings that are located on the outside portion of the power generation section, as shown in FIGS. 14, 16 and 23.

The magnetizing or exciter generator may be located in the center of the IROBW 1402. The exciter generator may be designed to deliver a constant power that is fed to the control/power circuit that increases or decreases the current delivery to the rotor windings/electromagnets. The current may be delivered to the electromagnets in pulsating manner that increases or decreases the magnetic field's strength in a repetitive form. The voltage, power and frequency of the total output power of the IROBW 1402 may be regulated. The magnetization of the electromagnets may also be regulated by the amplitude and/or frequency of the pulsating current which is preferably relative to the wind or liquid speed, torque and/or the rounds per minute (RPM) of the turning blades. This level of regulation enables the IROBW to harness small amounts of wind and efficiently convert it into electrical power (see FIGS. 8 and 9).

The pulse magnetic controlled generator (PMCG) may be comprised of a rotor with poles winding structure. The electromagnet and winding poles may be arranged in a 4:3 or 3:4 ratio. For example, the three phase PMCG may have windings in multiples of six and the electromagnets in multiples of eight, such as in a 48 electromagnets and 36 windings. The electromagnets may be arranged in a U-shape configuration with two electromagnets facing each other. The windings pass through the U-shape electromagnets. Similar to the MSG, the PMCG generator has multiple small generators all within one assembly. Using the example above, the stator has 36 winding poles and a rotor with 48 electromagnet poles for a total of six small generators. Each of the small generators may have three phases (A, B and C) where each phase is comprised of two windings for a total of six windings. The multiple small generators may be exposed to the rotor's 48 electromagnet poles and produce a full waveform of 360 degrees in all three phases in a 12.5% of one full rotor rotation. The output of each of the small generators within the PMCG generator may be coupled on the AC side or can be rectified then coupled after rectification. The PMGC electromagnets may e powered by an exciter generator. The exciter generator may be a separate generator or can be embedded within the PMGC.

The output of the exciter generator may be fed to an electronic circuit (See FIG. 11) that converts the AC power to DC power. The control circuit sends the current to the electromagnet in a pulsating manner such as in pulse width modulation. The control circuit may be comprised of sensors, monitoring circuits, and controller, such as a microprocessor or digital signal processor. The pulses produced by the control circuit are intended to control the magnetization of the electromagnets in order to achieve a desired waveform on the output of the PMGC) (See FIG. 10). Another function of the control circuit or control module may be to utilize any winding or electromagnet to build a desired waveform, such as the waveform of FIG. 24.

Turning to FIG. 24, a graph 2400 of a 60 Hz waveform 2402 generated by the MSG 2200 of FIG. 22 in accordance with an implementation of the invention is shown. Each set of winding in the MSG 2200 results in a portion of the waveform 2402, such as the three sections identified by 2404. In the 48 electromagnet example of the PMCG, the control circuit may produce one full 60 Hz wave form 2402 by using a set of windings to build the first 1/10^{th} of the 60 Hz waveform 2402, another set of windings to build the next 1/10 and so on.

The foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

1. A wind jet turbine, comprising:
a first set of fan blades;
a plurality of magnets that each has a magnetic field;
a cylinder having an inside and outside surface that supports the first set of fan blades on the inside surface and coupled to the plurality of magnets; and
at least one cable winding located apart from the magnets, such that the rotation of the cylinder results in the movement of the magnetic field across the at least one cable winding.

2. The wind jet turbine of claim 1, where the end of the cylinder has a zigzag shape.

3. The wind jet turbine of claim 1, where each of the fan blades in the first set of fan blades have a pitch that may be changed from a first position to a second position.

4. The wind jet turbine of claim 1, where the inside surface of the cylinder defines an opening that is not of uniform size.

5. (canceled)

6. (canceled)

7. (canceled)

8. The wind jet turbine of claim 1, further includes, a second set of fan blades that are on the outside surface of the cylinder supports.

9. The wind jet turbine of claim 8, where each of the fan blades in the second set of fan blades have a pitch that may be changed from a first position to a second position.

10. The wind jet turbine of claim 8, where the second set of fan blades are within a housing.

11. The wind jet turbine of claim 10, where the housing has a deflector that directs incoming liquid to the second set of fan blades.

12. (canceled)

13. (canceled)

14. (canceled)

15. (canceled)

16. (canceled)

17. The wind jet turbine of claim 1, where the magnets are inductions magnets.

18. The wind jet turbine of claim 17, where a controller controls the current passed to the induction magnets.

19. The wind jet turbine of claim 17, further includes a plurality of cable windings, where the controller activates the current to the induction magnets and generates alternating current from the plurality of cable windings.

20. (canceled)

21. The wind jet turbine of claim 17, where the controller controls activates the current to the induction magnets and generates direct current from the at least one cable winding.

22. The wind jet turbine of claim 1, includes a housing outside of the cylinder.

23.

[symbol]

24. A method of generating power with wind jet turbine, comprising:
transferring energy to a first set of fan blades in response to the first set of blades being struck by a liquid;
rotating a cylinder having an inside and outside surface that supports the first set of fan blades on the inside surface and coupled to a plurality of magnets with the energy received at the first set of fan blades; and
inducing a current in at least one cable winding located apart from the magnets when the rotation of the cylinder results in the movement of the magnetic field associated with each of the magnets across the at least one cable winding.

25. The method of claim 23, where the end of the cylinder has a zigzag shape.

26. The method of claim 23, further includes changing the pitch of each of the fan blades in the first set of fan blades from a first position to a second position.

27. The method of claim 23, further includes reducing the area that the liquid flows through as it passes through the cylinder.

28. (canceled)

29. The method of claim 27 further includes changing the pitch of each of the fan blades in the second set of fan blades from a first position to a second position.

30. The method of claim 27 includes housing the second set of fan blades within a housing.

31. The method of claim 29 further includes directing the liquid with a deflector the second set of fan blades.

32. (canceled)

33. The method of claim 23 where the magnets are permanent magnets.

34. The method of claim 23, includes controlling the magnets with electrical current passing through a coil.

35. (canceled)

36. The method of claim 34, includes generating alternating current at from the cable winding in response to the controller.
